(19) United States
(12) Patent Application Publication
(10) Pub. No.: US 2026/0358291 A1
(43) Pub. Date: Nov. 12, 2026

(54) GRAPHENE TRANSISTOR

(71) Applicant: IMPERIAL COLLEGE INNOVATIONS LIMITED, London (GB)

(72) Inventors: Benji Fenech SALERNO, London (GB); Martin HOLICKY, London (GB); Felice TORRISI, London (GB)

(21) Appl. No.: 19/146,393

(22) PCT Filed: Jan. 9, 2024
(86) PCT No.: PCT/EP2024/050401

§ 371 Date: Jul. 8, 2025

(30) Foreign Application Priority Data
Jul. 9, 2023 (GB) 2300285.0

(51) Int. Cl. G01N 27/414; B05D 1/02; B05D 3/02; C01B 32/19; C09D 11/037; C09D 11/52

(52) U.S. Cl. CPC G01N 27/4146; B05D 1/02; B05D 3/0254; C01B 32/19; C09D 11/037; C09D 11/52; G01N 27/4145; B05D 2320/00; B05D 2601/20; C01P 2004/03; C01P 2004/24; C01P 2004/61; C01P 2004/62; C01P 2004/64; C01P 2006/40

(57) ABSTRACT

The present disclosure is related to processes for the manufacture of electrolyte-gated graphene field effect transistors comprising deposition of ink compositions comprising graphene to form conductive films comprising graphene and the use of said transistors as chemo-and bio-sensors.

### TECHNICAL FIELD

The present disclosure is related to processes for the manufacture of electrolyte-gated graphene field effect transistors comprising deposition of ink compositions comprising graphene to form conductive films comprising graphene and the use of said transistors as chemo-and bio-sensors.

### BACKGROUND OF THE INVENTION

The pressing need for improved chemical and biological sensing platforms has ushered in a race for diagnostic technologies. Sensors need to satisfy a range of criteria, such as detecting for analytes sensitively and selectively within diagnostically-relevant ranges, in real-time, at a low-cost, and easily operated by the end user. In meeting such criteria, the applications span beyond health, and include environmental monitoring, agriculture, and food processing industry.

Graphene, a sheet of carbon atoms arranged in a hexagonal lattice, has been successfully used in a wide range of sensors ranging from simple ion detection, through gas sensing to highly specific and sensitive biomolecule recognition. Graphene has a range of highly attractive properties for sensing, including extremely high surface to volume ratio yielding excellent sensitivity, easy functionalisation due to its carbon chemistry and the possibility act as the channel in a field effect transistor (FETs) which allows for very sensitive and fast detection.

Graphene may comprise a sheet of a single layer (single layer graphene, SLG) or a few layers. Few-layer graphene (FLG) is a multi-layer of graphene with a number of layers comprised, but not limited to, 2-10 layers.

A graphene field effect transistor (GFET) consists of a film comprising graphene (including FLG) across the source and drain electrodes forming the FET channel with a third electrode, gate, separated by either a dielectric (dielectric-gated GFET, DG-GFET) or an electrolyte (electrolyte-gated GFET, EG-GFET, also referred to as solution-gated GFET, SG-GFET or liquid-gated GFET, LG-GFET). In both cases, a potential applied at the gate electrode can modulate the current flowing through the graphene channel due to the field effect. In case of EG-GFETs, the actual gate voltage seen by the channel may be affected by the double layer capacitance, graphene quantum capacitance and electrochemical potentials which enable the sensing of various analytes.

The selectivity of GFET sensors is enabled by functionalisation of the channel or the gate with a receptor molecule responding to a particular analyte. The breadth of receptor molecules used is extensive, and includes enzymes, aptamers, antibodies, PNAs, ssDNA and ion-selective membranes (ISMs).

The graphene film in EG-GFET sensors is typically achieved by chemical vapour deposition (CVD) of graphene on a copper foil and subsequent transfer of the graphene on the desired substrate. However, there are limitations to this approach and there remains a need for a simpler and more scalable approach for preparation of GFETS that can be used as chemo-and bio-sensors.

### SUMMARY OF THE INVENTION

A simple and scalable approach is available through solution-processable ink compositions comprising graphene which may be prepared by liquid-phase exfoliation (LPE), e.g. through sonication, shear mixing or microfluidisation, of graphite. The resulting ink compositions can be then deposited by e.g., spray-coating, ink-jet printing, screen-printing or aerosol-jet printing.

Films deposited from such ink compositions can achieve a network of flakes with low flake thickness, high mobility and high throughput at a fraction of the cost of the competing approaches.

Described herein is a novel route to manufacture electrolyte-gated graphene field effect transistors (G-GFET) that can advantageously be used in combination with printed circuit board (PCB) technology.

Accordingly, in a first aspect there is provided a process for preparing an electrolyte-gated field effect transistor, comprising:
providing a substrate comprising a source electrode and a drain electrode and a surface comprising a sample region;
providing an ink composition comprising graphene and a stabilising agent (for example, polyvinylpyrrolidone (PVP));
coating the ink composition on the surface of the substrate to provide a film comprising graphene on the surface of the substrate forming a channel between the source electrode and the drain electrode and positioned to be over at least a first portion of the sample region.

The process may comprise providing a gate electrode on the substrate, wherein the gate electrode is positioned in contact with a second part of the sample region and wherein the gate electrode is configured such that it does not contact the film once the film is provided. In other words, the film is not positioned on the second part of the sample region where the gate electrode is position.

The substrate may be a printed circuit board (PCB). The source electrode, drain electrode and gate electrode may be printed onto the PCB substrate.

Alternatively, the process may comprise providing a gate electrode remote to the substrate, wherein the gate electrode is configurable to contact an electrolyte solution placed on sample region and wherein the gate electrode does not contact the film.

The sample region may comprise a well configured to hold a liquid sample.

The process may further comprise providing a reference electrode.

The ink composition may comprise graphene at a concentration of at least about 0.01 mg/mL, at least about 0.05 mg/mL, at least about 0.1 mg/mL. The ink composition may comprise graphene at a concentration of up to about 10 mg/mL, up to about 5 mg/mL or up to about 3 mg/mL. The ink composition may comprise graphene at a concentration of about 0.01 mg/mL to about 10 mg/mL, optionally about 1 to about 3 mg/mL.

The stabiliser is preferably PVP. The PVP may have a weight average molecular weight (Mw) of at least about 10,000 Da, at least about 20,000 Da, at least about 30,000 Da or at least about 40,000 Da may be used. Preferably, the PVP may have a Mw of at most about 100,000 Da. For example, PVP of about 10,000 Da to about 100,000 Da may be used. Preferably, the PVP is PVP 40,000 Da.

The ink composition may further comprise one or more further stabilising agents in a liquid dispersant or solvent. The one or more further stabilising agents may be selected from PVP, functionalised PVP or co-block polymers of PVP, polymers or surfactants (e.g. anionic, cationic, zwitterionic, bio-surfactants. Exemplary stabilising agents include sodium cholate (SC), sodium dodecylsulfate (SDS), sodium dodecylbenzenesulfonate (SDBS), Pluronic F-127, Triton X-100, poly(sodium-4-styrene sulfonate) (PSS), flavin mononucleotide sodium salt (FMNS), carboxy-methyl cellulose (CMC) and arabic gum (AG) and the like, or a mixture thereof. The liquid dispersant or solvent may be 2-propanol, water, alcohols (e.g. ethanol, butanol, propanol), ethers, esters, amides (DMF, NMP, CHP, DMEU), amines (e.g. hexylamine), halogenated (e.g. chloroform, dichlorobenzene), carbon disulphide, carbonates (e.g. ethylene carbonate, propylene carbonate), hydrocarbons (e.g. hexane, benzene, toluene), or neat polymers (e.g. acrylates, epoxies) , or a mixture thereof.

The ink composition may be prepared by liquid phase exfoliation of graphite. The ink composition may be prepared by combining graphite in a liquid dispersant or solvent, optionally adding one or more stabilising agents, and exfoliating the graphite to form an ink composition comprising graphene. The graphite may be amorphous graphite, flake graphite, vein graphite, etc; natural or synthetic.

The ink composition may have a surface tension of at least about 10 mN/m, or at least about 20 mN/m. The ink composition may have a surface tension of less than about 80 mN/m, less than about 60 mN/m, less than about 40 mN/m, less than about 30 mN/m, or less than about 25 nM/m. The ink composition may have a surface tension of about 10 to about 80 mN/m, optionally less than about 25 mN/m.

The ink composition may have a viscosity of less than about 100 mPa s, less than about 75 mPa s, less than about 50 mPa s, less than about 25 mPa s, less than about 10 mPa s, less than about 5 mPa s, less than about 4 mPa s, less than about 3 mPa s, or less than about 2 mPa.

The ink composition may be stable to sedimentation for at least 1 minute, optionally at least 1 hour, optionally at least 24 hours.

The graphene may comprise nanoplatelets, for example wherein the mean lateral flake size of the nanoplatelets may be less than about 50 μm, less than about 40 μm, less than about 30 μm, less than about 20 μm, less than about 10 μm, less than about 1 μm, less than about 900 nm, less than about 800 nm, less than about 700 nm, less than about 600 nm or less than about 500 nm. The mean lateral flake size of the nanoplatelets may at least about 50 nm, at least about 60 nm, at least about 70 nm, at least about 80 nm, at least about 90 nm, at least about 100 nm, at least about 150 nm or at least about 200 nm. The mean lateral flake size of the nanoplatelets may be about 50 nm to 50 μm, optionally about 200 to about 500 nm. The average thickness of the graphene nanoplatelets may be less than about 30 nm, less than about 25 nm, less than about 20 nm, less than about 15 nm, less than about 10 nm, less than about 5 or less than about 4 nm. The average thickness of the graphene nanoplatelets may be at least about 0.3 nm, at least about 0.34 nm, at least about 0.6 nm, at least 0.7 nm or at least about 1 nm. The average thickness of the graphene nanoplatelets may be about 0.3 to about 30 nm, about 1 to about 30 nm, about 1 to about 10 nm optionally less than about 4 nm.

Coating the ink composition on the surface of the substrate may comprise spray-coating the ink composition, as well as (but not limited to) inkjet printing, aerosol jet printing, blade coating, rod coating, screen printing, spin coating

The process may further comprise annealing the film, optionally photonic annealing or heat treatment. Alternatively, treatment with a mild reducing agent (such as vitamin C) may be used.

The film preferably has a channel resistance of less than about 100 kΩ, optionally about 100 Ω.

The film may have a thickness of less than about 500nm, less than about 450 nm, less than about 400 nm, less than about 350 nm, less than about 300 nm or less than about 250 nm.

The process may further comprise deposition of a selective layer onto the film. The selective layer may be for example an ion selective membranes or an enzymatic reactor.

The PCB substrate may incorporate a source of heat. The PCB substrate may thereby act as a heater for the device, thus allowing for each cartridge to have an in-built thermometer and heater which will allow for any measurement to take place at a constant controlled and set temperature.

In a second aspect, there is provided a process for preparing an electrolyte-gated field effect transistor, comprising:
providing a printed circuit board (PCB) as a substrate, the substrate comprising a source electrode and a drain electrode and a surface comprising a sample region;
providing an ink composition comprising graphene and a stabilising agent; and
coating the ink composition on the surface of the substrate to provide a film comprising graphene on the surface of the substrate forming a channel between the source electrode and the drain electrode and positioned to be over at least a first portion of the sample region.

The process may comprise providing a gate electrode on the substrate, wherein the gate electrode is positioned in contact with a second part of the sample region and wherein the gate electrode does not contact the film. In other words, the film is not positioned over the second part of the sample region where the gate electrode is positioned.

The source electrode, drain electrode and gate electrode may be fabricated onto the PCB substrate.

The sample region may comprise a well configured to hold a liquid sample.

The process may further comprise providing a reference electrode.

The ink composition may comprise graphene at a concentration of at least about 0.01 mg/mL, at least about 0.05 mg/mL, at least about 0.1 mg/mL. The ink composition may comprise graphene at a concentration of up to about 10 mg/mL, up to about 5 mg/mL or up to about 3 mg/mL. The ink composition may comprise graphene at a concentration of about 0.01 mg/mL to about 10 mg/mL, optionally about 1 to about 3 mg/mL.

The stabilising agent may be polyvinylpyrrolidone (PVP). The PVP may have a weight average molecular weight (Mw) of at least about 10,000 Da, at least about 20,000 Da, at least about 30,000 Da or at least about 40,000 Da may be used. Preferably, the PVP may have a Mw of at most about 100,000 Da. For example, PVP of about 10,000 Da to about 100,000 Da may be used. Preferably, the PVP is PVP 40,000 Da.

The ink composition may further comprise one or more additional stabilising agents in a liquid dispersant or solvent. The one or more additional stabilising agents may be selected from PVP, functionalised PVP or co-block polymers of PVP, polymers or surfactants (e.g. anionic, cationic, zwitterionic, bio-surfactants. Exemplary stabilising agents include sodium cholate (SC), sodium dodecylsulfate (SDS), sodium dodecylbenzenesulfonate (SDBS), Pluronic F-127, Triton X-100, poly(sodium-4-styrene sulfonate) (PSS), flavin mononucleotide sodium salt (FMNS), carboxy-methyl cellulose (CMC) and arabic gum (AG) and the like, or a mixture thereof. The liquid dispersant or solvent may be 2-propanol, water, alcohols (e.g. ethanol, butanol, propanol), ethers, esters, amides (DMF, NMP, CHP, DMEU), amines (e.g. hexylamine), halogenated (e.g. chloroform, dichlorobenzene), carbon disulphide, carbonates (e.g. ethylene carbonate, propylene carbonate), hydrocarbons (e.g. hexane, benzene, toluene), or neat polymers (e.g. acrylates, epoxies), or a mixture thereof.

The ink composition may be prepared by liquid phase exfoliation of graphite. The ink composition may be prepared by combining graphite in a liquid dispersant or solvent, optionally adding one or more stabilising agents, and exfoliating the graphite to form an ink composition comprising graphene. The graphite may be amorphous graphite, flake graphite, vein graphite, etc; natural or synthetic.

The ink composition may have a surface tension of at least about 10 mN/m, or at least about 20 mN/m. The ink composition may have a surface tension of less than about 80 mN/m, less than about 60 mN/m, less than about 40 mN/m, less than about 30 mN/m, or less than about 25 nM/m. The ink composition may have a surface tension of about 10 to about 80 mN/m, optionally less than about 25 mN/m.

The ink composition may have a viscosity of less than about 100 mPa s, less than about 75 mPa s, less than about 50 mPa s, less than about 25 mPa s, less than about 10 mPa s, less than about 5 mPa s, less than about 4 mPa s, less than about 3 mPa s, or less than about 2 mPa.

The ink composition may be stable to sedimentation for at least 1 minute, optionally at least 1 hour, optionally at least 24 hours.

The graphene may comprise nanoplatelets, for example wherein the mean lateral flake size of the nanoplatelets may be less than about 50 μm, less than about 40 μm, less than about 30 μm, less than about 20 μm, less than about 10 μm, less than about 1 μm, less than about 900 nm, less than about 800 nm, less than about 700 nm, less than about 600 nm or less than about 500 nm. The mean lateral flake size of the nanoplatelets may at least about 50 nm, at least about 60 nm, at least about 70 nm, at least about 80 nm, at least about 90 nm, at least about 100 nm, at least about 150 nm or at least about 200 nm. The mean lateral flake size of the nanoplatelets may be about 50 nm to 50 μm, optionally about 200 to about 500 nm. The average thickness of the graphene nanoplatelets may be less than about 30 nm, less than about 25 nm, less than about 20 nm, less than about 15 nm, less than about 10 nm, less than about 5 or less than about 4 nm. The average thickness of the graphene nanoplatelets may be at least about 0.3 nm, at least about 0.34 nm, at least about 0.6 nm, at least 0.7 nm or at least about 1 nm. The average thickness of the graphene nanoplatelets may be about 0.3 to about 30 nm, about 1 to about 30 nm, about 1 to about 10 nm optionally less than about 4 nm.

Coating the ink composition on the surface of the substrate may comprise spray-coating the ink composition, as well as (but not limited to) inkjet printing, aerosol jet printing, blade coating, rod coating, screen printing, spin coating

The process may further comprise annealing the film, optionally photonic annealing or heat treatment. Alternatively, treatment with a mild reducing agent (such as vitamin C) may be used.

The film preferably has a channel resistance of less than about 100 kΩ, optionally about 100 Ω.

The film may have a thickness of less than about 500nm, less than about 450 nm, less than about 400 nm, less than about 350 nm, less than about 300 nm or less than about 250 nm.

The process may further comprise deposition of a selective layer onto the film. The selective layer may be for example an ion selective membranes or an enzymatic reactor.

The PCB substrate may incorporate a source of heat. The PCB substrate may thereby act as a heater for the device, thus allowing for each cartridge to have an in-built thermometer and heater which will allow for any measurement to take place at a constant controlled and set temperature.

In a third aspect, provided herein is the use of a self-adhesive in ink composition comprising graphene, a stabilising agent (for example, polyvinylpyrrolidone), and optionally one or more additional stabilising agents, in a liquid dispersant or solvent in the preparation of a field effect transistor. The ink composition may be according to the first aspect of the invention. Any features of the ink composition in relation to the first or second aspect of the invention apply mutatis mutandis to the third aspect of the invention.

In a fourth aspect, provided herein is an electrolyte-gated graphene field effect transistor as prepared according to the process of the first aspect of the invention. Any features of the electrolyte-gated graphene field effect transistor in relation to the first or second aspect of the invention apply mutatis mutandis to the fourth aspect of the invention.

In a fifth aspect, provided herein is an electrolyte-gated graphene field effect transistor, comprising:
a substrate comprising a source electrode and a drain electrode and a surface comprising a sample region;
a film comprising graphene and a polyvinylpyrrolidone decomposition product forming a channel between the source electrode and the drain electrode on the surface of the substrate, and position to be over at least a first portion of the sample region; and
a gate electrode is positioned in contact with a second portion of the sample region and wherein the gate electrode does not contact the film;
wherein the film has a channel resistance of less than about 100 kΩ and thickness of less than about 500 nm.

The substrate may be a printed circuit board (PCB). The source electrode, drain electrode and gate electrode may be printed onto the PCB substrate.

The sample region may comprise a well configured to hold a liquid sample.

The electrolyte-gated graphene field effect transistor may comprise a reference electrode. The graphene may comprise nanoplatelets, for example wherein the mean lateral flake size of the nanoplatelets may be less than about 50 μm, less than about 40 μm, less than about 30 μm, less than about 20 μm, less than about 10 μm, less than about 1 μm, less than about 900 nm, less than about 800 nm, less than about 700 nm, less than about 600 nm or less than about 500 nm. The mean lateral flake size of the nanoplatelets may at least about 50 nm, at least about 60 nm, at least about 70 nm, at least about 80 nm, at least about 90 nm, at least about 100 nm, at least about 150 nm or at least about 200 nm. The mean lateral flake size of the nanoplatelets may be about 50 nm to 50 μm, optionally about 200 to about 500 nm. The average thickness of the graphene nanoplatelets may be less than about 30 nm, less than about 25 nm, less than about 20 nm, less than about 15 nm, less than about 10 nm, less than about 5 or less than about 4 nm. The average thickness of the graphene nanoplatelets may be at least about 0.3 nm, at least about 0.34 nm, at least about 0.6 nm, at least 0.7 nm or at least about 1 nm. The average thickness of the graphene nanoplatelets may be about 0.3 to about 30 nm, about 1 to about 30 nm, about 1 to about 10 nm optionally less than about 4 nm.

The film preferably has a channel resistance of about 100 Ω.

The film may have a thickness of less than about 450 nm, less than about 400 nm, less than about 350 nm, less than about 300 nm or less than about 250 nm.

The electrolyte-gated graphene field effect transistor may comprise a selective layer provided on the film. The selective layer may be for example an ion selective membranes or an enzymatic reactor.

The PCB substrate may incorporate a source of heat.

In a sixth aspect, provided herein is an array comprising a plurality of electrolyte-gated graphene field effect transistors described herein.

In a seventh aspect, provided herein is a sensor comprising an electrolyte-gated graphene field effect transistor described herein or an array as described herein.

In an eighth aspect, provided herein is the use of a sensor according to the sixth aspect as an in vitro diagnostic device (e.g. point of care diagnostics) or as an agriculture or environmental monitoring device.

In a ninth aspect, provided herein is a process, use, electrolyte-gated graphene field effect transistor, array or film as described herein, with reference to the accompanying figures.

Embodiments described herein in relation to the first aspect of the present invention apply mutatis mutandis to the second to ninth aspects of the present invention.

### SUMMARY OF FIGURES

FIG. 1 shows a) OAS of the LPE graphene ink diluted by a factor of 61. b) DLS and OAS stability analysis. DLS indicates stability against aggregation, with <3% decrease in relative size over 190 days whilst UV-Vis indicates gradual sedimentation initiating after 72 days of storage, peaking at 14.8% at day 190. c) Overlapping Raman spectra before and after photonic annealing. d) AFM statistics showing a log normal distribution of peaking at 190 nm. e) AFM statistics showing a log normal distribution of peaking at 2.65 nm, which equates to a mean of 5-layer thick graphene when adjusted for a 1 nm water layer. f) TEM image of a typical LPE graphene flake before photonic annealing.

FIG. 2 shows a) Photo of the GFET on PCB. b) Micrographs of the device—optical microscopy (left), SEM (right). c) Depth profile of ENIG (left) and Pt (right) plating of the PCB. The approximate depth after 1500 seconds is 120 nm (0.08 nm/s). d) Cyclic voltammetry between —1 and 1V using the original ENIG plated electrodes and Pt-plated electrodes, showing the nickel redox peaks and substantially greater stability of the Pt electrodes. e) Contact angle of a drop of the graphene ink on FR-4 substrate, showing excellent wetting. f) IV curves for the graphene channel showing the importance of annealing. The electrodes were dry (not in a solution) during the measurement. The resistances were 309.8 Ω (not annealed) and 112.4, 107.9 and 114.7Ω for light pulse energies of 2.5J/cm², 3.75 J/cm² and 5 J/cm², respectively.

FIG. 3 shows the manufacturing process to make an exemplary four-terminal graphene PCB-based EG-GFET for chemical sensing.

FIG. 4 shows a) Schematic of the four-terminal EG-GFET. b) Forward and backward sweeps in 10 mmol L⁻¹ PB solution at VDS=+200 mV. c) Forward sweeps at incrementally decreasing pH from pH all to pH 3, showing a linearity of 25.8+0.5 mV/pH in d). e) Diminishing pH switching showing an ultimate resolution of 0.04 pH units, with response times of <10 s. f) ID sensitivity of 143 μA/pH through a linear range of pH 11 to pH 3 which is >2800 greater than the I_{G} response.

FIG. 5 shows a) Sweep of a Na⁺-selective EG-GFET in 10 mmol L⁻¹ K-PB. b) Incremental addition of Na⁺ results in proportional decreased in the ID. c) The GFET response has to Na⁺ is 145.5+3.9 μA/pH in the range of 20 μmol L⁻¹ to 5 mmol L⁻¹.

### DETAILED DESCRIPTION

Described herein is a novel route to manufacture electrolyte-gated graphene field effect transistors (EG-GFET) that can advantageously be used in combination with printed circuit board (PCB) technology. A commercial PCB process may be used to obtain the substrates in an accessible, scalable, and low-cost way and the graphene channel is subsequently deposited by, for example, spray-coating.

The choice of these methods enables scalability and allows us to deposit small quantities of ink compositions, selectively on the target areas, thus improving throughput and improving deposition yield.

The function of such devices is shown by detecting two analytes, pH and Na+, which are relevant for a wide range of fields, for instance, point of care diagnostics, agriculture and environmental monitoring. The sensor devices are characterised in terms of their sensitivity, selectivity, limit-of-detection (LOD), limit of quantification (LOQ) and linear (dynamic) range. Among other characteristics, the devices described herein provide beneficial properties in terms of e.g. resolution, robustness, precision and accuracy.

An electrolyte is a liquid medium in which one or more salts are dissolved, releasing ions and forming a conductive solution.

An EG-FET comprises three electrodes, namely, the source, the drain, and the gate. The source and drain electrodes are generally connected through a channel formed from a film comprising a semiconductor or a semimetal material (i.e. graphene), while an electrolyte is used to separate the gate electrode from the semiconducting or semimetal material. By applying a voltage between the gate and channel electrodes, it is possible to modulate the current flowing between source and drain due to the field effect on the channel.

Described herein is a process for preparing an EG-GFET, comprising:
providing a substrate comprising a source electrode and a drain electrode and a surface comprising a sample region;
providing an ink composition comprising graphene and a stabilising agent (for example, polyvinylpyrrolidone (PVP)); and
coating the ink composition on the surface of the substrate to provide a film comprising graphene on the surface of the substrate forming a channel between the source electrode and the drain electrode and positioned to be over at least a first portion of the sample region.

The process described herein comprises depositing a film comprising graphene on a substrate from an ink composition comprising graphene. The film comprising graphene serves as the channel layer in the EG-GFET.

As used herein, graphene includes both single and few layer graphene. The graphene described herein may therefore comprise SLG, FLG or combinations thereof. Few-layer graphene (FLG) is a multi-layer of graphene with a number of layers comprised, but not limited to, 2-10 layers, preferably 5 or fewer layers of graphene.

The ink composition described herein may be prepared by liquid phase exfoliation (LPE) of graphite. Said LPE methods may provide pristine graphene nanoplatelets (also described herein as flakes). Exemplary LPE methods that may be utilised to produce the graphene for the ink composition include sonication assisted LPE, high shear mixing, microfluidisation, vertexing, as well as chemical exfoliation. Preferably, the LPE method is sonication assisted LPE, as described in the examples, in particular where the ink composition is coated using inkjet printing or spray coating processes. Exemplary methods for preparing ink compositions comprising graphene are described in E Piatti et al., Nature Electronics, 2021, 4, 12, 893-905, T Carey et al., arXiv preprint arXiv: 2011.12359, 2020, X Ji et al., Journal of Materials Chemistry C, 2020, 8, 44, 15788-15794, S Qiang et al., Nanoscale, 2019, 11, 20, 9912-9919, T Carey et al., ACS applied materials & interfaces, 2018, 10, 23, 19948-19956, T Carey et al., Nature communications, 2017, 8, 1, 1-11, PG Karagiannidis et al., ACS nano, 2017, 11, 3, 2742-2755, J Ren et al., Carbon, 2017, 222, 622-630, F Torrisi et al., ACS nano, 2012, 6, 4, 2992-3006, U.S. Pat. No. 10,9068,14B, 9,718,972B2, US20200235245A1 and US20170028674A1, the entire contents of which are hereby incorporated by reference.

The ink compositions described herein may be prepared by combining graphite in a liquid dispersant or solvent, optionally adding one or more stabilising agents, and exfoliating the graphite to form an ink composition comprising graphene. For example, the ink compositions described herein may be prepared by combining graphite in a liquid dispersant or solvent, adding one or more stabilising agents, and exfoliating the graphite to form an ink composition comprising graphene. The graphite used for liquid phase exfoliation may be, but is not limited to, amorphous graphite, flake graphite, vein graphite. The graphite may be natural or synthetic graphite.

The graphene in the ink compositions described herein may comprise nanoplatelets. The mean lateral flake size of the graphene nanoplatelets may be less than about 50 μm, less than about 40 μm, less than about 30 μm, less than about 20 μm, less than about 10 μm, less than about 1 μm, less than about 900 nm, less than about 800 nm, less than about 700 nm, less than about 600 nm or less than about 500 nm. The mean lateral flake size of the nanoplatelets may at least about 50 nm, at least about 60 nm, at least about 70 nm, at least about 80 nm, at least about 90 nm, at least about 100 nm, at least about 150 nm or at least about 200 nm. The mean lateral flake size of the nanoplatelets may be about 50 nm to 50 μm. For spray coating, the mean lateral flake size of the nanoplatelets is preferably about 200 to about 5000 nm.

The mean lateral flake size may be determined using microscopy methods, for example, atomic force microscopy (AFM), scanning electron microscopy (SEM) or transmission electron microscopy (TEM). AFM may be used to measure the lateral flake size (<S>) of a graphene nanoplatelet. <S> is defined as <S>=√x.y, where x and y are the length and width of the nanoplatelets. The mean lateral flake size is the modal value of <S> of a population of graphene nanoplatelets.

The average thickness of the graphene nanoplatelets may be less than about 30 nm, less than about 25 nm, less than about 20 nm, less than about 15 nm, less than about 10 nm, less than about 5 or less than about 4 nm. The average thickness of the graphene nanoplatelets may be at least 0.3 nm at least 0.34 nm, at least about 0.6 nm, at least 0.7 nm or at least about 1 nm. For example, the average thickness of SLG may be at least about 0.3 nm (e.g. at least about 0.34 nm). The average thickness of FLG may be at least about 0.6 nm (e.g. at least about 0.7 nm or more). The average thickness of the graphene nanoplatelets may be about 0.3 to about 30 nm. For spray coating, the thickness should preferably be less than about 10 nm, for example, about 1 to about 10 nm.

The average thickness may be measured using microscopy methods, for example electron microscopy or atomic force microscopy (AFM). The average thickness is the number average of the thickness <t> of a population of graphene nanoplatelets.

For example, as described in the examples, for a population of about 300 individually measured graphene nanoplatelets, a log-normal distribution of the <S> and <t> were observed, which peak at <S>=about 190 mm and <t>=about 2.65 nm. Assuming a thickness of about 1 nm and a graphene interlayer distance of 0.34 nm, we measure a mean flake thickness of about 5 layers can be determined, indicating the ink composition may comprise a combination of single-layer and few-layer graphene.

The graphene in the ink compositions described herein may comprise single-layer graphene or FLGs or a combination thereof.

As described, mean lateral flake size may also be measured by SEM. A population of about 70 individually measured graphene nanoplatelets were measured and similarly, a lognormal distribution was observed peaking at <S>=about 182 nm, which closely aligns with the values obtained using AFM.

Adhesion of the deposited film may be imparted by choice of stabiliser. The usage of PVP as a stabiliser, allows the graphene to self-adhere to the surface of the substrate. Usage of PVP as a stabiliser annuls the need for adhesives to be applied to the surface of the sensor, imparts structural stability and simplifies the device fabrication.

The ink compositions described herein may preferably comprise PVP. In particular, the PVP serves a dual-role in the ink compositions: 1) to stabilise the graphene dispersions; 2) to act as an adhesive molecule between the graphene nanoplatelets and the underlying substrate following deposition.

A range of PVP molecular weights may be used. Preferably, PVP having a weight average molecular weight (Mw) of at least about 10,000 Da, at least about 20,000 Da, at least about 30,000 Da or at least about 40,000 Da may be used. Preferably, the PVP may have a Mw of at most about 100,000 Da. For example, PVP of about 10,000 Da to about 100,000 Da may be used. Preferably, the PVP is PVP 40,000 Da.

The ink compositions may further comprise one or more additional stabilising agents. The one or more stabilising agents may be selected from PVP, functionalised PVP or co-block polymers of PVP, polymers or surfactants (e.g. anionic, cationic, zwitterionic, bio-surfactants. As would be appreciated, if the ink composition comprises PVP as the stabilising agent, the one or more optionally present additional stabilising agents are selected from stabilising agents other than PVP. Exemplary stabilising agents include sodium cholate (SC), sodium dodecylsulfate (SDS), sodium dodecylbenzenesulfonate (SDBS), Pluronic F-127, Triton X-100, poly(sodium-4-styrene sulfonate) (PSS), flavin mononucleotide sodium salt (FMNS), carboxy-methyl cellulose (CMC) and arabic gum (AG) and the like, or a mixture thereof.

The ink composition comprises a liquid medium, for example a liquid dispersant or solvent within which the graphene is dispersed. The liquid dispersant or solvent may be 2-propanol, water, alcohols (e.g. ethanol, butanol, propanol), ethers, esters, amides (DMF, NMP, CHP, DMEU), amines (e.g. hexylamine), halogenated (e.g. chloroform, dichlorobenzene), carbon disulphide, carbonates (e.g. ethylene carbonate, propylene carbonate), hydrocarbons (e.g. hexane, benzene, toluene), or neat polymers (e.g. acrylates, epoxies), or a mixture thereof. Accordingly, also provided herein is an ink composition comprising graphene, a stablising agent (for example, polyvinylpyrrolidone), and optionally one or more additional stabilising agents, in a liquid dispersant or solvent.

The ink composition described herein may advantageously have a surface tension of about 10 to about 80 mN/m. For spray coating, a surface tension of about 25 mN/m is preferable.

Goniometry may be used to measure the surface tension of the inks. For example, surface tension measurements may be measured using the pendant drop method on a goniometer (e.g. a First Ten Angstroms, FTA1000B). Surface tension may be measured at 25 °C.

The ink composition described herein may advantageously have a viscosity (e.g. a dynamic viscosity) of less than about 100 mPa s. For spray coating, viscosity of less than about 2 mPa is preferable.

Viscometry may be used to measure the viscosity of the inks. For example, measurement may be carried out using a rheometer, as described in the examples. Viscosity may be measured at 25 °C.

The ink composition may be stable to sedimentation for at least 1 minute, optionally at least 1 hour, optionally at least 24 hours.

The ink composition's stability to sedimentation and aggregation can be measured using techniques such as, but not limited to, thermogravimetric analysis, dynamic light scattering, zeta potential measurements and optical spectroscopy. For spray coating, the ink composition is preferably stable for longer than the time required to deposit the film on the sensor structure.

The ink composition may be considered stable to sedimentation and aggregation if more than about 50% of the graphene nanoplatelets are in suspension without aggregation. Preferably, the ink composition is considered stable to sedimentation and aggregation if more than about 90% of the graphene nanoplatelets are in suspension without aggregation. This may be measured using DLS and inferring the changes in the distribution of SLGs and FLGs (brought about by sedimentation or aggregation) by monitoring the relative intensity weighted mean hydrodynamic size (Z_{R}) with time, in conjunction with the ink compositions polydispersity, as described in the examples.

The ink composition may be deposited on the substrate by spray coating. Increasing the atomisation gas pressure during spray coating may aid formation of smaller droplets of the ink composition which may help contribute to formation of uniform films. For example, pressures of about 40 psi may be used.

Following spray coating, the deposited film may be dried by evaporation.

The process may further comprise annealing the film. Annealing may be carried out using photonic annealing or heat treatment. Alternatively, treatment with a mild reducing agent (such as vitamin C) may be used. Annealing may help improve the electrical performance and adhesion.

The PVP stabiliser in the ink composition is electrically insulating and may negatively affect the overall conductivity of the nanostructured graphene thin films. PVP mainly (for example, more than about 95% by mass) decomposes into gaseous products when heated to temperatures above 400 °C according, heat treatment (e.g. to temperatures of about 400 °C or greater) may be used to anneal the films.

However, in some cases, high temperatures may be above the decomposition temperature of the substrate (for example, for a PCB, and potentially the insulation layer on top of it). Annealing can also, therefore, be achieved by photonic methods. For example, a Xenon intense pulsed light (IPL) source which degrades the polymer may be used. Annealing may comprise exposing the film to IPL energy of up to about 5 J/cm², up to about 4 J/cm², up to about 3 J/cm², up to about 2.5 J/cm², up to about 2 J/cm², or up to about 1 J/cm². Preferably the IPL energy is at least about 0.1 J/cm² or at least about 0.5 J/cm². For example, about 0.5 J/cm² to about 5 J/cm².

Annealing produces a film comprising graphene and a decomposition product of the PVP.

The process may further comprise deposition of a selective layer onto the graphene channel (i.e. the film comprising graphene), which may help tune the selectivity of the device. Device selectivity may be imparted by the deposition of a layer of material that can discriminate between different analytes. Two such techniques for example include ion selective membranes and enzymatic reactors. In the former case, devices may utilise an impregnated-PVC ion selective membrane, which comprises a thin layer of PVC impregnated with small quantities of ion-selective macromolecules in the membrane. The selectivity of the membrane can be tailored by changing the macromolecules. In the case of enzymatic reactors, enzymes confer the device selectivity. Enzymes are biological catalysts with highly specific active sites that catalyse the build-up or degradation of compounds. Whilst so doing, charged species may be produced which can in turn be detected by the sensor.

The substrate itself containing the transistor electrodes as the electrode geometry needs to be accurate and repeatable for repeatable sensors. For EG-GFETs, the electrodes also need to be electrochemically inert (for example, typically made from gold). The geometry of the channel and the ratio of its width to length impact the overall channel conductivity and the signal to noise ratio. Shorter channel length or longer channel width may result in higher currents at a given drain-source voltage (VDs) which then enables clear separation between the currents flowing through the graphene that are relevant to sensing and any leakage currents flowing through the electrolyte.

The substrate comprises a source electrode and a drain electrode and a surface comprising a sample region. As would be appreciated, the sample region is the portion of the surface of the substrate where the electrolyte solution (within which an analyte sample is provided) is placed.

The electrodes may be any suitable material, as would be appreciated by a skilled person. Processing steps in improve the chemical inertness of the electrode may be carried out. For example, the electrodes may be electroplated with a chemically inert layer (e.g. platinum). This is particularly advantageous for electrodes that are integrated into the surface of the substrate (e.g. the source electrode, the drain electrode and/or the gate electrode). Where integrated into the substrate (e.g. where the substrate is a PCB), the reference electrode may also be processed to improve chemical inertness.

The present process may be used in conjunction with commercial printed circuit board (PCB) technology. Thus, the substrate used may be a rigid or flexible PCB. By combining ink compositions comprising pristine graphene with PCB designs, it is possible to produce high quality EG-GFETs at very low costs, in a scalable manner and in high volumes. Where the substrate is a PCB, the sample region is a portion of the surface of the PCB.

A PCB comprises a laminated sandwich structure of conductive and insulating layers: each of the conductive layers is designed with an artwork pattern of traces, planes and other features etched from one or more sheet layers of copper laminated onto and/or between sheet layers of a non-conductive substrate (e.g. glass-epoxy or polyimide film).

The electrodes may be integrated into the surface of the PCB (e.g. printed or fabricated on the surface of the PCB). Preferably, the drain electrode and the source electrode are integrated into the PCB surface. The gate electrode may also be integrated into the PCB. A reference electrode may also be present and may be integrated into the PCB.

In the process and EG-GFET described herein, a gate electrode is provided. The gate electrode may be provided on the substrate (for example, integrated into the surface of a PCB). The gate electrode may be positioned in contact with a second part of the sample region, such that when the electrolyte is present it is in electrical communication with the gate electrode. The gate electrode is separated from the film, i.e. it does not contact the film. The electrolyte may therefore act as an insulating layer between the film and the gate electrode.

In a process described herein, coating the ink composition on the surface of the substrate to provide a film comprising graphene on the surface of the substrate may be carried out such that the film is not positioned on the second portion of the sample region, where the gate electrode is positioned.

The gate electrode need not be provided on (or integrated with) the substrate. For example, the gate electrode may be provided remote to the substrate, but positioned such that it is able to be electrical communication with an electrolyte present in the sample region.

Where the substrate is a PCB, it may be electroplated prior to deposition of the ink composition to improve chemical inertness.

As described herein, the graphene film is printed onto the substrate (e.g. a PCB cartridge) to form the channel and to create printed graphene field effect transistor (GFET) sensors. These sensors can be functionalised using a multitude of methods to change target. GFETs are ideal sensing structures, as the active graphene channel provides the sensor with a large and sensitive surface area which can be used to detect the target molecules. This presents with a simple, affordable, and scalable system that integrates into existing infrastructure that will allow for immediate sensing of multi-analyte mixtures for real-time detection by end users.

Also described, therefore, is a process for preparing an electrolyte-gated field effect transistor, comprising:
providing a PCB as a substrate, the PCB substrate comprising a source electrode and a drain electrode and a surface comprising a sample region;
providing an ink composition comprising graphene and a stabilising agent; and
coating the ink composition on the surface of the substrate to provide a film comprising graphene on the surface of the substrate forming a channel between the source electrode and the drain electrode and positioned to be over at least a first portion of the sample region. The stabilising agent may be PVP, as described herein. The ink composition may further comprise one or more additional stabilising agents in a liquid dispersant or solvent, as described herein.

Also provided herein is an EG-GFET as prepared according to the process described herein. For example, provided herein is an EG-GFET, comprising:
a substrate comprising a source electrode and a drain electrode and a surface comprising a sample region;
a film comprising graphene and a polyvinylpyrrolidone decomposition product forming a channel between the source electrode and the drain electrode on the surface of the substrate, and position to be over at least a first portion of the sample region; and
a gate electrode is positioned in contact with a second part of the sample region and wherein the gate electrode does not contact the film;
wherein the film has a channel resistance of less than about 100 kΩ and thickness of less than about 500 nm.

The EG-FET described herein may be used in the fabrication of chemosensors and biosensors. Said chemosensors and biosensors may comprise an EG-FET as described herein or an array comprising a plurality of EG-FETs.

The point of chemosensors and biosensors may be used in a wide range of fields, for instance as point of care diagnostics or in agriculture or environmental monitoring.

For example, the device operates as a graphene field effect transistor (GFET). As target species get closer to the surface of the device, a shift in the Dirac point is observed which can be used. By measuring the drain-source current (I_{D}) at a constant gate voltage (V_{G}), it is possible to observe the shift of the Dirac point as an increase (or decrease) of the I_{D}.

The PCB substrate, where used, may incorporate a source of heat thereby acting as a heater for the device, thus allowing for each cartridge to have an in-built thermometer and heater which will allow for any measurement to take place at a controlled and set temperature.

We have demonstrated three functionalisation strategies that allow the device to detect for different classes of analytes:

The use of graphene may make the device pH sensitive, owing to the presence of defects on the graphene flake network. As such, the use of these defects has allowed us to reversibly detect for pH 4-10, with response recorded within seconds, and a resolution of 0.03 pH units.

The GFETs can be coated with a selective ion membrane, which allows for only certain ionic species to permeate through the device. The device fabricated may utilise an impregnated-PVC ion selective membrane, which may comprise a thin layer of PVC impregnated with small quantities of ion-selective macromolecules in the membrane. The selectivity of the membrane can be tailored by changing the macromolecules. Detection of common cations (including Li⁺, K⁺, NH₄⁺, Mg²⁺, Ca²⁺, Hg²⁺, Cd²⁺, Pb²⁺) and anions (including Cl⁻, NO₂⁻, NO₃⁻, I⁻, SCN⁻, ClO₄⁻) may be possible. Use of a membrane was demonstrated to detect for Na⁺ with a limit of detection (LOD) of about 125 nM.

It is also possible to couple our GFETs with enzymes. Enzymes are selective biological catalysts that can catalyse the building or breakdown of compounds. In so doing, some of these reactions result in the formation of ionic species. By detecting these ionic species, our GFET devices are capable of selectively measuring for the presence of the enzymatic substrate. As an example, we demonstrated this work by measuring for the antibiotic penicillin using β-lactamase. Penicillin was detected in the solution at a LOD of 50 μM and with a reaction time seconds. The application of such enzymatic detection is not limited to penicillin and it can be applied to families of drugs, neurotransmitters and metabolic products.

Whilst the GFET described herein has been demonstrated for use in the detection of health-related analytes, the implication of this technology goes beyond healthcare and is applicable to any scenario where a panel of chemical markers need to be quickly, and routinely analysed at low cost. The agricultural sector for example is yearning for economic products that can facilitate ‘in-field’ (or ‘in situ’) testing of livestock and plant health. Similarly, environmental surveillance still relies heavily on costly lab-based testing methods, with communities often having to wait weeks or months for results that can have a direct impact on their livelihood and wellbeing.

Throughout the description and claims of this specification, the words “comprise” and “contain” and variations of the words, for example “comprising” and “comprises”, mean “including but not limited to”, and are not intended to (and do not) exclude other components. In any of the embodiment described herein, reference to “comprising” also encompasses “consisting essentially of”.

Features described above in relation to each aspect of the present invention also represent features of each other aspect of the present invention subject to a technical incompatibility that would prevent such a combination of preferred features. Furthermore, it will be evident to the skilled person that advantages set out above in respect of each aspect of the present invention are also offered by each other aspect of the present invention.

### EXAMPLES

The following examples are merely illustrative examples of the invention described herein and are not intended to be limiting upon the scope of the invention.

### Methods

### Formulation of LPEG Inks

50 mg mL⁻¹ of graphite were added to 0.4 mg mL⁻¹ of polyvinylpyrrolidone (PVP) (Merck, Average Mw=40,000) in 2-propanol (Sigma Aldrich, ACS reagent ≥99.8% purity). The mixture was exfoliated by immersion of the mixture in a bath sonicator (Fisherbrand Elmasonic S150 Ultrasonication Unit, 300 W effective power) for 9 hours. The resultant mixture was subsequently centrifuged (Beckman Alegra 64R, F06050 Fixed-Angle Rotor) at 13,000 g (mean) for 1 hour. After centrifugation, the top 80% of the supernatant was retained at the LPEG ink.

### Characterisation Techniques

Optical spectroscopy. Flake concentration was estimated using an Agilent Cary 60 UV-Vis spectrophotometer in a quartz cuvette. Inks were appropriately diluted to ensure the region of interest had an absorption value in the range of 0.1-1.0. In the ink stability assays, OAS was used to supplement the DLS data, by analysing the rate of ink flake sedimentation in the ink as a function of the change in relative absorbance (ΔA_{R}). The relative absorbance (A_{R}) is defined as the absorbance values normalised to the absorbance at day 1, with ΔA_{R} subsequently defined as ΔA_{R}=A_{R-1}−A_{R-X}, where A_{R-1} and A_{R-X} being the A_{R} at day 1 and day x respectively.

Raman spectra were measured on a Renishaw inVia micro-Raman spectrometer (WiRe 4.1) using a x20 objective with a green 532 nm laser and 1800 lines/mm grating. An incident power of ≤1 mW was used to avoid thermal damage. Samples for Raman spectroscopy were deposited as thin films on Si/SiO₂ (Si-Mat, 200 nm dry thermal oxide).

Dynamic light scattering (DLS or photon correlation spectroscopy, PCS) was carried out on a Zetasizer Ultra. The scattering angle was set to 175°. Dispersions were freshly diluted in 0.4 mg mL⁻¹ PVP in IPA. Measurements were collected at 25 °C with 60 s of settling time. Stability assays were conducted by storing aliquot of inks in Eppendorf tubes under ambient conditions. Aliquots were retrieved over time and diluted for analysis. A dilution factor of 61 was determined by identifying the ink concentration range which yielded a constant Z average. In the ink stability assays, the intensity weighted mean hydrodynamic size (Z-average or Z) of the population of particles in a dispersion was used to infer changes in the distribution of SLGs and FLGs (brought about by sedimentation or aggregation) by monitoring the relative changes in Z with time, in conjunction with the sample's polydispersity. The relative Z (Z_{R}) is defined as Z normalised to Z at day 1. Subsequently, ΔZ_{R} is defined as ΔZ_{R}=Z_{R-1}−Z_{R-X}, where Z_{R-1}; and Z_{R-X} being the Z_{R} at day 1 and day x respectively.

Electron microscopy. Scanning electron microscopy images were acquired using an ultra-high-resolution LEO Gemini 1525 FEG-SEM. Images were collected by measuring secondary electrons using the In Lens and SE2 detectors respectively.

Transmission electron microscopy images were acquired using a JEOL 2100Plus STEM. Dispersions of LPEG inks were diluted to 0.01 mg mL⁻¹ and deposited on holey carbon TEM grids (Agar Scientific, 200 mesh copper grids).

Scanning probe microscopy. Atomic force microscopy measurements were measured on an Asylum Research MFP 3D Scanning Probe Microscope. Measurements were collected in tapping mode using a general-purpose silicon AFM probe (Nunano SCOUT 70), with a 70 kHz resonance frequency and tip radius curvature of <10 nm. LPEG dispersions were diluted to 0.01 mg mL⁻¹ and deposited on Si/SiO₂ (Si-Mat, 200 nm dry thermal oxide). Prior to deposition, the Si/SiO₂ wafers were cleaned of insoluble organic contaminants using the first step of the RCA cleaning method, whereby wafers were cleaned in a 5:1:1 mixture of deionised water, 30% (w/w) H₂ O₂ (Merck) and 25% ammonium hydroxide solution in water (Acros Organics, extra pure) at 80 °C for 10 minutes. AFM analysis was carried out using Gwydion (v 2.58).

Rheological measurements. Surface tension measurements were measured using the pendant drop method on a goniometer (First Ten Angstroms, FTA1000B) using the Drop Shape Analysis (v2.0) software. Drops were formed using a 20-gauge stainless steel dispenser needle. A rheometer (HAAKE Mars 60) using a double coaxial cylinder geometry and the data fitted using a cross model to determine the infinite-rate viscosity. A double gap coaxial cylinder geometry is necessary for low viscosity inks which are not readily held within cone and plate, and parallel plate systems. Moreover, such systems allow for better outflow controls at high shear rates whilst maintaining temperatures with improved uniformity. All measurements were taken at 25 °C.

X-ray photoelectron spectroscopy (XPS). XPS spectra were acquired using the Thermo Scientific K-Alpha system incorporating a micro-focused Al Kα X-ray source. The etching (profiling) was performed using the built-in argon ion sputtering gun, at 500 eV cluster energy and “medium” current setting, with an approximate 0.08 nm/s etch rate. The analysis of graphene samples was performed on Si/SiO₂ substrates to avoid interfering signals from the FR-4 substrate and any silicon substrate signals were ignored for the purpose of quantitative analysis.

### Device Fabrication

PCB Design. A custom PCB design was created using Eagle CAD (Autodesk Inc., USA, v9.6.2). The source and drain were designed as an interdigitated electrode array with 100 μm fingers and 100 μm gaps. Two further rectangular electrodes were added for separate gate and reference electrodes. The PCB designs were sent to a commercial foundry (Eurocircuits, Belgium) for manufacture using standard PCB processes. The substrate was FR-4 (a glass-epoxy laminate) and the 35 μm copper was plated by the manufacturer with electroless nickel and gold coatings (ENIG) of 4 μm and 75 nm, respectively.

Electroplating. On reception, the PCB electrodes were electroplated with platinum (Spa Plating) using a stainless-steel sheet counter electrode to improve their chemical inertness. Plating was done at constant current of 1 mA for 30 minutes. Plating quality was inspected visually using optical microscopy and using XPS.

Spray coating. The graphene channel was deposited by spray coating of the LPEG ink onto the interdigitated source-drain electrodes. The LPEG ink was spray-coated using a custom-built automatic spray-coating setup consisting of an airbrush mounted on an XYZ movable platform with electronic gas flow control. The nozzle-substrate distance was chosen to 40 mm to cover the whole channel in a single pass. 40 psi N₂ gas was used as the atomisation gas and using a 0.4 mm nozzle moving at 4,000 mm min⁻¹ (the maximum movement speed the setup could achieve). The amount of ink pipetted into the spray-coater reservoir was kept constant at 0.4 mL to ensure repeatable deposition.

Annealing. Photonic annealing of the graphene film was performed using a xenon intense pulse light source (530-1400 nm) with <1.5 ms flash duration and a dose of 2.5 J cm². A steel stencil identical to the one used for spray-coating was used to selective anneal the LPEG channel area.

Reference electrode. 1 μL of a commercial Ag/AgCl paste (Sun Chemical) was deposited on top of the PCB electrode denoted for the reference electrode. Care was taken to cover the entire electrode with the Ag/AgCl paste. The device was then dried at 60 °C for 1 hour.

Ion selective transistor. A solution of 80 mg mL⁻¹ of the ion selective membrane was produced by dissolving 264 mg of polyvinyl chloride (PVC) (Sigma Aldrich, high molecular weight, Selectophore grade), 530 mg (1.24 mmol) of bis(2-ethylhexyl) sebacate (DOS) (Sigma Aldrich, selectophore grade) plasticiser, 5.6 mg (5.64 μmol) of sodium ionophore X (IUPAC: 4-tert-Butylcalix[4]arenetetraacetic acid tetraethyl ester, Sigma Aldrich, selectophore grade), and 1.6 mg (3.23 μmol) of potassium tetrakis ((4-chlorophenyl)-borate (Sigma Aldrich, selectophore grade) ion exchanger in 10 mL of tetrahydrofuran (THF) (Sigma Aldrich, selectophore grade) and shaken for 10 minutes until the solution turned translucent. A 9:1 dilution in THF was conducted to produce a solution of 8 mg mL⁻¹. The solution was stored at 2-8 °C.

The ion selective solution was deposited on top of the transistor using drop-casting. 5 μL of the 8 mg mL⁻¹ solution was deposited on top of the transistor and allowed 30 seconds to dry. A further 2.5 μL of 80 mg mL⁻¹ was deposited on top. The ion selective membrane (ISM) was allowed to dry for 12 hours in ambient conditions. Prior to first characterisation, the membraned devices were immersed for 15 minutes in a solution 0.1 mol L⁻¹ NaCl (VWR, ACS reagent) followed by a 10-minute rinse in deionised water. The sodium selective sensors were reused by dipping in deionised water for 10 minutes.

### Device Measurements

Electrical measurements of the graphene transistor devices were collected on a Keithley 4200 (Keithley Interactive Test Environment [KITE] v 9.1), using a delay factor of 1.3, filter factor of 3 and A/D aperture times of 5 PLC. Measurements were taken at the lowest available source and current range. Measurements were taken at VDS=+200 mV unless stated otherwise.

Peak to peak noise measurements were measured by measuring the difference between the maximum and minimum values within a region where no response signal is expected. Alternatively, the RMS noise was measured as the standard deviation of the baseline noise since mean of a noise signal is zero.

pH-sensor measurements were conducted in 0.01 mol L⁻¹ phosphate buffer (PB) solution using a Hanna Edge (HI2020) with a digital pH electrode with integrated temperature sensor (HI11310). The pH electrode was calibrated daily using calibration solutions at pH 4.01, 7.01 and 10.01. The PB solution was prepared by dissolving 7.541 mmol of sodium phosphate dibasic heptahydrate, Na₂HPO₄.7H₂O, (Sigma Aldrich, ACS reagent) and 2.459 mmol of sodium phosphate monobasic monohydrate, NaH₂PO₄.H₂O, (Sigma Aldrich, ACS reagent, ≥98% purity) in 1L of deionised water. pH adjustments were made by appropriate addition of 1.0 mol L⁻¹ of orthophosphoric acid (Scientific Laboratory Supplies, 85% w/w) or 1.0 mol L⁻¹ sodium hydroxide solution (Scientific Laboratory Supplies, >99% purity).

Detection for sodium ions was conducted by sequential additions of Na₂SO₄ (VWR, ≥98% purity) solutions in deionised water or potassium phosphate buffer solution (K-PB). K-PB was prepared by dissolving 7.541 mmol of potassium phosphate dibasic, K₂HPO₄, (Sigma Aldrich, ACS reagent, ≥98% purity) and 2.459 mmol of potassium phosphate monobasic, KH₂PO₄, (Sigma Aldrich, ACS reagent, ≥99%) in 1 L of deionised water.

### Results and Discussion

### Synthesis & Characterisation of Graphene Ink

From the wide range of possible graphene ink preparation methods, we chose sonication-assisted liquid phase exfoliation due to its simplicity and compatibility with low-boiling solvents. To enable rapid deposition through spray-coating, a low-boiling solvent with a low surface tension is desirable. 2-propanol (isopropanol) has a boiling point 82 °C and a surface tension of only 20.34 mN m⁻¹ which satisfies both criteria. Unlike other solvents used to prepare graphene dispersions in the literature, such as N-methyl-2-pyrrolidone (NMP), 2-propanol is non-toxic. To obtain a stable and highly concentrated ink, a biocompatible polymeric stabiliser, polyvinylpyrrolidone (PVP), was added.

The ultrasonication of graphite powder in presence of PVP and subsequent purification through centrifugation yielded a highly concentrated ink, the optical absorption spectrum (OAS) is shown in FIG. 1a. Applying the Beer-Lambert law A=εcl where A s the absorbance, c ink concentration, l the path length and & the absorption coefficient, the concentration of the graphene ink is estimated to be 0.818 mg mL⁻¹. The absorption coefficient was assumed to be 2460 L g⁻¹ m⁻¹ at 660 nm based on reference. The shape of OAS spectra in FIG. 1a is typical for graphene with an almost constant absorption in the visible portion of the spectrum and a peak in the UV region corresponding to the Van Hove singularity at the M point of the Brillouin zone.

The long-term stability of the ink is important and was investigated using OAS (to observe the total concentration) and dynamic light scattering (DLS) to monitor the flake size. Without external calibration, the absolute particle values as measured by DLS are not considered reliable for direct determination of the absolute size of single-or few-layer graphene (SLG or FLG, respectively) flakes as the particle size is inferred using the Stokes-Einstein relation which assumes a spherical particle shape. However, it is possible to infer changes in the distribution of SLGs and FLGs (brought about by sedimentation or aggregation) by monitoring the relative intensity weighted mean hydrodynamic size (Z_{R}) (with time, in conjunction with the sample's polydispersity. FIG. 1b (top panel) shows the change in Z_{R} (ΔZ_{R}), represented as the percentage change of the original Z_{R}, and demonstrates that within a 190-day period there is only a minimal change in the average flake shape and no aggregate formation is observed. Moreover, the graphene ink shows a monodisperse profile indicated by a single peak profile and a consistent polydispersity index over 190 days. OAS absorbance measurements showed only a 14% decrease in the change in relative absorbance (ΔA_{R}), represented as the percentage change of the original AR, over a 190-day period (FIG. 1b, bottom panel), further demonstrating the excellent stability of the ink.

The surface tension of the ink was determined to be 18.50±0.25 mN m⁻¹, lower than 20.34 nM m⁻¹ for pure 2-propanol at 25 °C, due to the added PVP stabiliser. Rheology measurements identified the dynamic viscosity to be 2.35+0.1 mPa s, higher than 2.01 mPa s for the pure 2-propanol due to the presence of the stabiliser and graphene flakes.

Atomic force microscopy (AFM) was used to measure the mean lateral flake size (<S>) and thickness (<t>) of more than 300 individually measured graphene flakes. <S> is defined as <S>=√xy, where x and y are the length and width of the flakes. Both the <S> and <t> have a log-normal distribution, which peak at <S>=190 mm (FIG. 1d) and <t >=2.65 nm (FIG. 1e). Assuming a thickness of 1 nm and a graphene interlayer distance of 0.34 nm, we obtain a mean flake thickness 5 layers, indicating the graphene ink is composed of a combination of SLGs and FLGs. The was also measured using scanning electron microscopy (SEM). A sample of 70 flakes were measured and similarly, a lognormal distribution was observed peaking at a mean of 182 nm which closely aligns with the values obtained using AFM. This is further supported by transmission electron microscopy (TEM), with a representative flake shown in FIG. 1f.

The quality of the SLG and FLG flake quality was monitored using Raman spectroscopy. FIG. 1c shows typical Raman spectra of the graphene ink deposited on SiO2, before (red, lower curve) and after (black, upper curve) photonic annealing (discussed in further detail in ‘Device Fabrication’), revealing the presence of characteristic graphene peaks. Pristine graphene shows a G peak at 1580 cm⁻¹ originates from the E_{2g} phono vibration at the centre of the Brillouin zone mode and is always present in graphene Raman spectra. The D peak at 1347 cm⁻¹ is instigated by the presence of defects within the sp² hybridised structure and is activated through double resonance. Defects may manifest within the basal plane or at the edge of the flakes but are predominantly the latter in ultrasonic-assisted liquid phase exfoliated material. The minute D′ peak at 1623 cm⁻¹ is instigated by double resonance, potentially caused by an intravalley process in which two points K and K′ on the same cone are connected. The 2D peak at 2691 cm⁻¹ is an overtone of the D peak which arises from the conservation of momentum of two phonons with opposite wave vectors. Consequently, the Lorentzian shaped 2D peak can be observed in the absence of the D peak as it does not require defects for its activation. The second order peak is a single band in single layer graphene, but splits into further peaks with increasing graphene layers because of the changing band structure.

### Device Fabrication

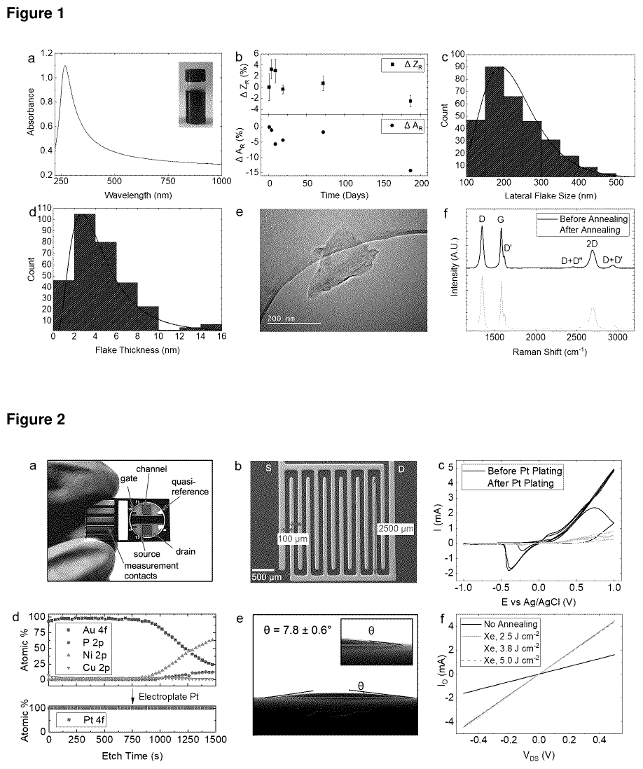

An EG-FET PCB test strip was developed and contains 4 electrodes-drain, source, gate and reference (FIG. 2a)., a gate electrode and a reference electrode. Each test strip integrates a pair of such. The test strip is manufactured using commercial PCB manufacturing techniques on a glass-epoxy laminate substrate (FR-4) to maximise the manufacturability of the substrate. The EG-GFET channel is comprised of 14 fingers, 100 μm wide, with 100 μm spacing and 2500 μm in length (FIG. 2 b). The overall channel area is 3.25mm². The electrical connections are achieved using 2.54 mm-spaced gold-plated contacts, which fit into standard card edge connectors.

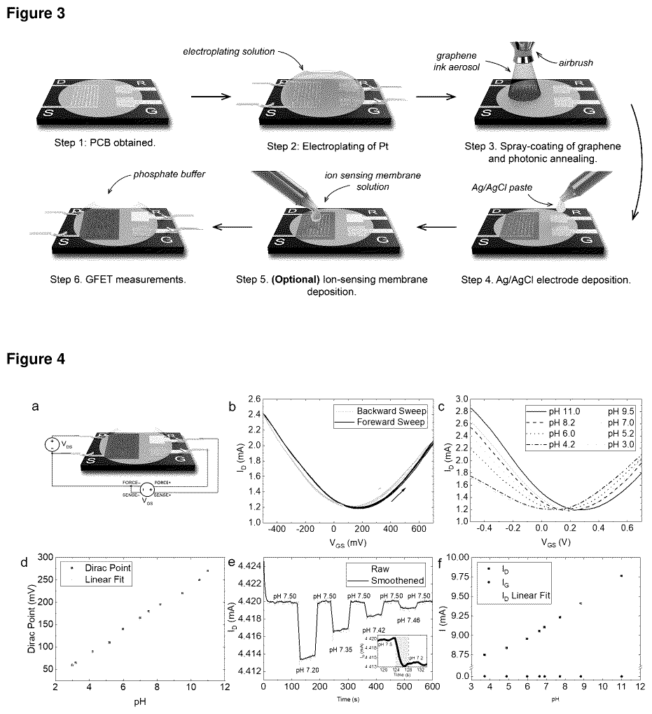

The surface of EG-FET strip is plated with 4 μm of nickel and 75 nm of gold in a commercial electroless process (ENIG) to ensure inertness of the electrodes. However, clear Faradaic peaks from oxidation (at positive potentials vs. Ag/AgCI reference) and reduction (−0.4 V vs. Ag/AgCl) of nickel or copper were observed (FIG. 2d, blue curve) upon running cycling voltammetry in a phosphate buffer. Ideally, no peaks beyond those associated with electrolysis of would be observed. XPS depth profiling revealed the presence of copper (FIG. 2c top) in addition to gold, likely coming from uneven coverage of the gold layer. A 0.5 μm layer of platinum was therefore electroplated onto the electrodes, to render the electrodes inert (FIG. 3, step 2). XPS profiling analysis shows the presence of pure platinum only (FIG. 2c, bottom) with no other elements present and cyclic voltammetry sweeps (FIG. 2d) show substantially reduced Faradaic peak, typically associated with water electrolysis on platinum electrode.

To enable a repeatable and scalable deposition of graphene onto the PCB substrate, automatic spray-coating was used (FIG. 3 step 3). The contact angle between the ink and the FR-4 substrate was only 7.8+0.6° (FIG. 2e) and shows excellent wetting which contributes to film uniformity as the individual drops coalesce into a thin film before evaporating. Furthermore, Increasing the atomisation gas pressure results in the formation of smaller droplets which also contributes to formation of uniform films-the maximum pressure (40 psi) permitted by the setup was used.

The PVP stabiliser in the graphene ink is electrically insulating and it is known to negatively affect the overall conductivity of the nanostructured graphene thin films. PVP decomposes into gaseous products when heated to temperatures above 400 °C but such high temperatures are above the decomposition temperature of the PCB substrate and the insulation layer on top of it. PVP removal can also be achieved by a xenon intense pulsed light (IPL) source which degrades the polymer. We investigated the effect of exposing our sprayed graphene films to three different IPL energies, on the electrical resistance of the EG-GFET channel (FIG. 2f). Xenon IPL exposure at 2.5, J/cm², 3.75 J/cm² and 5 J/cm² resulted in a similar increase of the resistance from XX Ohms (not exposed, red curve) to 309.8 22 (not annealed) and 112.4, 107.9 and 114.72 for light pulse energies of 2.5 J/cm², 3.75 J/cm² and 5 J/cm², respectively. The with the intermediate IPL exposure (3.75 J/cm² ), damage to the PCB insulating layer (solder mask) was observed in the form of a slight colour change. At the highest IPL exposure (5 J/cm²), the solder mask changed colour from black to grey and a considerable amount of smoke was observed. Therefore, the lowest energy was used for all subsequent experiments (2.5 J/cm²).

### Device Operation

The FIG. 4a is the basic unit component of our platform. The EG-GFET is a four-terminal device, comprising of the platinised source and drain electrodes which are the contacts to the sprayed graphene channel, a platinised gate electrode, and an Ag/AgCl reference electrode (FIG. 4a). It is possible to produce an array of GFET structures by proportionally increasing the quantity of source, drains and channel materials. All device terminals were either connected to high input impedance inputs (reference electrode, >1 GΩ source meter unit input impedance) or the current was measured to ensure a complete understanding of the current flows occurring and ensuring proper interpretation of the device response.

We first characterised the gate modulation of the EG-GFETs. Our EG-GFETs were initially investigated in phosphate buffer (PB) solutions of 10 mmol L⁻¹. FIG. 4b shows three cycles of ID plotted against the gate voltage (VGS), which shows a typical ambipolar graphene field-effect curve with the forward sweep (red curve) going from −500 mV to +700 mV and the backward sweep (blue curve) going from +700 mV to −500 mV. The Dirac point (also referred to as the charge neutrality point or CNP) of the device at pH=7 is found at VGS=+170 mV for the forward sweep and 130 mV for the backward sweep, resulting in a hysteresis of 40 mV for this measurement. The hysteresis observed is a well-known phenomenon in EG-GFETs. Computational and Raman spectroscopy studies have suggested that the hysteresis is caused at least in part by electrochemical processes in the aqueous layer in contact with graphene. The electrochemical reduction of oxygen, O2+2 H₂O+4e⁻=4OH⁻, occurs spontaneously at the graphene-water interface is thought to be the primary source of interference. Reducing the dissolved oxygen content will result in a decrease in I_{G} and hysteresis but purging samples of dissolved oxygen would not be practical for real-world analysis. Consequently, have arbitrarily chosen to conduct any further analysis using the forward sweep and the hysteresis effect does not appear to manifest in any drastic capacity at constant VGS.

We then investigated the EG-GFETs response to changes in pH. FIG. 4c shows a shift of the Dirac point to the left with decreasing pH from 11.0 to 3.0. The pH-dependent shift in the Dirac point is shown in FIG. 4d, with a maximum Dirac point of 270 mV at pH 11. A linear fit (red dashed line) reveals a sensitivity of 25.8+0.5 mV/pH, over a linear range of pH 11 to pH 3. Whilst pristine (defectless) graphene should not respond to changes in pH, the pH sensitivity is enabled by unintentional defects imparted during the LPE process. Although below the theoretical maximum predicted by the Nernst equation (59.16 mV/pH), the sensitivity is in-line with that observed for devices emanating from alternative graphene fabrication techniques such CVD-grown graphene on SiO₂ (21-22 mV/pH)75, suspended graphene (17 mV/pH), epitaxial graphene on silicon carbide (19 mV/pH)77 and mechanically exfoliated graphene on SiO₂ (20 mV/pH).

The VGS sweeps were used to identify the ideal VGS for constant VGS sensing. A VGS value of +50 mV was chosen for pH sensing as it is in the linear regime of the I_{D} response and is also the VGS at which the minimum I_{G} occurs. Minimising I_{G} is integral to minimising noise and drift, improving device lifespan, and ensuring robustness. The pH resolution is ultimately limited by the signal to noise ratio of the measurement setup.

FIG. 4e shows the response of ID (at VGS=+50 mV and VDS=+200 mV) to diminishing additions of acid and base. The baseline peak-to-peak I_{D} noise is 1 μA whilst root mean square (RMS) I_{D} noise was 0.2 μA. Adjusting the pH from 7.50 to 7.20 caused I_{D} to drop from 4.420 mA to 4.414 mV. The inset in FIG. 4e shows a response time of 4 s (blue shading) for a pH change of 0.3. Subsequent adjustment of the pH from 7.20 back to 7.50 caused I_{D} to return to 4.420 mA. The device resolution, defined as the minimum change in signal discernible between continuous flows, was determined in this manner by the subsequent additions of acid and base in diminishing quantities, yielding a resolution of 0.04 pH units for the EG-GFET. The response time and resolution are in line with previously reported pH-sensitive EG-GFET devices, demonstrating our ability to fabricate devices using in-expensive, scalable manufacturing techniques with similar performance characteristics to those based on CVD75 and mechanical exfoliation.

At constant VGS and VDS, the sensitivity of the device may alternatively be described as a function of change in ID. FIG. 4f shows a plot of ID values (black data points) at VDS=+200 mV and VGS=+50 mV. A linear fit (red dashed line) was plotted through the data points, showing a sensitivity of 143+7 μA/pH through a dynamic range of pH 11.0 to 3.0. The sensitivity of I_{D} to pH, is over three magnitudes higher than the sensitivity of I_{G} (blue data points), which is 0.05+0.02 μA/pH over the same range, thus excluding the possibility of electrolysis playing a significant role in the sensor response to pH. When operated in these conditions, the EG-GFET operating lifetime exceeds 50 hours and is primarily limited by the quality of the reference electrode.

The utility of EG-GFETs resides on their versatility towards targeted detection of further species beyond H₃O+/OH. We tested the suitability of our platform to detect for Na+ by depositing a sodium-selective membrane as a proof-of-concept of the platform's potential use for ion-selective detection applications. A thin polyvinylchloride (PVC)-based ion selective membrane (ISM) impregnated with ‘sodium ionophore X’ (see ‘Methods’) was deposited on top of the graphene channel of the EG-GFET. The ion-selective EG-GFET responds to the activity of the target ion with a higher sensitivity than other species, allowing for targeted measurements. The extent of this selectivity is dependent on a range of factors such as membrane and analyte composition. In the ion-selective EG-GFET, a change of potential is experienced at the surface of the EG-GFET channel, which in turn is observed as a shift in Dirac point and a subsequent drop in ID.

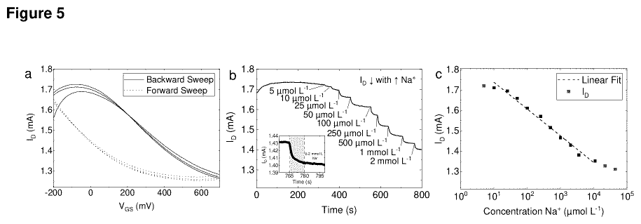

FIG. 5b shows decreasing I_{D} in response to incremental additions of Na+ to the ion selective EG-GFET at VDS=+200 mV and VGS=+50 mV. The limit of detection (LOD), defined as the lowest quantity of analyte signal that can be discriminated from the baseline noise, and is recorded as 5 μmol L⁻¹ for Na⁺. The inset in FIG. 5b, shows a response time of 15 s for the addition of 2 mmol L⁻¹ Na⁺ within the linear range of the ion selective EG-GFET. A plot of the ID response as a function of Na⁺ concentration is plotted in FIG. 5c. The Na⁺ selective EG-GFET has a linear range between 20 μmol L⁻¹ to 5 mmol L⁻¹, as is evidenced by the log-linear fit (red dashed line) showing a sensitivity of 143+4 μA/log₁₀Na⁺. The limit of quantification of 20 μmol L⁻¹.

The exact parameters of the ion-selective EG-GFETs may be tuned by adjusting the chemical and physical composition of the ISMs, tailoring devices to meet specific application criteria. The versatility of ion selective detection is immediately evident for its utility in health but may also be of further use in environmental and veterinary care. Moreover, the platform structure allows for the fabrication of several arrays of electrodes which can detect for multiple analytes within a sample.

### CONCLUSIONS

In summary, this works demonstrates the first application of a sprayed graphene transistor within a lab-on-substrate (e.g. PCB) architecture for the detection of pH and selective ion sensing. We document a step-by-step procedure that makes use of commonly available chemicals, components, and techniques for the fabrication of low-cost chemosensors and biosensors. By combining the production of graphene inks with spray coating, we can produce highly reproducible graphene transistor devices on (PCB) substrates. Moreover, we demonstrate the utility of the device for the sensing of pH between pH 3 and 11, with a resolution of 0.02 pH units, a response time of <10 seconds and a sensitivity of 25.8 mV/pH (Dirac point shift) which is in line with performances obtained using mechanically exfoliated and CVD-grown graphene. Finally, we also demonstrate the deposition of selective ion membranes on the surface of the graphene transistor for the detection of sodium as a proof-of-principle structure, with a sensitivity of 145+4 μA/log₁₀[Na⁺] through a linear range of 20 μmol L⁻¹ to 5 mmol L⁻¹.

While preferred embodiments of the present invention have been shown and described herein, it will be apparent to those skilled in the art that such embodiments are provided by way of example only. It will be appreciated that variations to the foregoing embodiments of the invention can be made while still falling within the scope of the invention. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

It will be appreciated that many of the features described above, particularly of the preferred embodiments, are inventive in their own right and not just as part of an embodiment of the present invention. Independent protection may be sought for these features in addition to or alternative to any invention presently claimed.

1. A process for preparing an electrolyte-gated field effect transistor, comprising:
providing a substrate comprising a source electrode and a drain electrode and a surface comprising a sample region;
providing an ink composition comprising graphene and a stabilising agent; and
coating the ink composition on the surface of the substrate to provide a film comprising graphene on the surface of the substrate forming a channel between the source electrode and the drain electrode and positioned to be over at least a first portion of the sample region.

2. The process of claim 1, comprising providing a gate electrode on the substrate, wherein the gate electrode is positioned in contact with a second part of the sample region and wherein the gate electrode does not contact the film.

3. The process of claim 1, wherein the substrate is a printed circuit board (PCB).

4. The process of claim 1, comprising providing a gate electrode remote to the substrate, wherein the gate electrode is configurable to contact an electrolyte solution placed on sample region and wherein the gate electrode does not contact the film.

5. A process for preparing an electrolyte-gated field effect transistor, comprising:
providing a printed circuit board (PCB) as a substrate, the substrate comprising a source electrode and a drain electrode and a surface comprising a sample region;
providing an ink composition comprising graphene and a stabilising agent; and
coating the ink composition on the surface of the substrate to provide a film comprising graphene on the surface of the substrate forming a channel between the source electrode and the drain electrode and positioned to be over at least a first portion of the sample region.

6. The process of claim 1, wherein the sample region comprises a well configured to hold a liquid sample.

7. The process of claim 1, further comprising providing a reference electrode.

8. The process of claim 1, wherein the ink composition comprises graphene at a concentration of about 0.01 mg/mL to about 10 mg/mL.

9. The process of claim 1, wherein the ink composition further comprises one or more stabilising agents in a liquid dispersant or solvent.

10. The process of claim 9, wherein:
a) the one or more stabilising agents are each selected from polyvinylpyrrolidone (PVP), polymers or surfactants; and/or
b) the liquid dispersant or solvent is 2-propanol, water, alcohols, ethers, esters, amides, amines, halogenated chloroform, dichlorobenzene, carbon disulphide, carbonates, hydrocarbons, or neat polymers, or a mixture thereof.

11. The process of claim 1, wherein the ink composition is prepared by liquid phase exfoliation of graphite and exfoliating the graphite to form an ink composition comprising graphene.

12. The process of claim 11, wherein the graphite is amorphous graphite, flake graphite, vein graphite; natural or synthetic.

13. The process of claim 1, wherein the ink composition:
a) has a surface tension of about 10 to about 80 mN/m; and/or
b) has a viscosity of less than about 100 mPa s; and/or
c) is stable to sedimentation for at least 1 minute.

14. The process of claim 1, wherein the graphene comprises nanoplatelets, wherein the mean lateral flake size of the nanoplatelets is about 50 nm to 50 μm, and the average thickness of the flakes is about 1 to about 30 nm.

15. The process of claim 1, wherein coating the ink composition on the surface of the substrate comprises spray-coating the ink composition.

16. The process of claims 1 further comprising annealing the film.

17. The process of claims 1, wherein the film has a channel resistance of less than about 100 kΩ.

18. The process of claim 1, wherein the film has thickness of less than about 500 nm.

19. The process of claim 1, wherein the substrate is a PCB and the PCB substrate incorporates a source of heat.

20. (canceled)

21. (canceled)

22. An electrolyte-gated graphene field effect transistor, comprising:
a substrate comprising a source electrode and a drain electrode and a surface comprising a sample region;
a film comprising graphene and a polyvinylpyrrolidone decomposition product forming a channel between the source electrode and the drain electrode on the surface of the substrate, and positioned to be over at least a first portion of the sample region; and
a gate electrode positioned in contact with a second part of the sample region and wherein the gate electrode does not contact the film;
wherein the film has a channel resistance of less than about 100 kΩ and thickness of less than about 500 nm.

23. (canceled)

24. (canceled)

25. (canceled)
